(19) United States
(12) Patent Application Publication
(10) Pub. No.: US 2024/0281685 A1
(43) Pub. Date: Aug. 22, 2024

(54) SYSTEMS AND METHODS FOR DETECTION OF ANOMALOUS BEHAVIOR

(71) Applicant: JPMORGAN CHASE BANK, N.A., New York, NY (US)

(72) Inventors: Ibrahim GHALYAN, Stewartsville, NJ (US); Avi HOLLANDER, Columbus, OH (US); Rachael KENNEY, Dublin, OH (US)

(21) Appl. No.: 18/170,342

(22) Filed: Feb. 16, 2023

(51) Int. Cl. G06N 7/01

(52) U.S. Cl. CPC G06N 7/01

(57) ABSTRACT

In some aspects, the techniques described herein relate to a method including: receiving a time series signal; converting the time series signal into a sequence of symbols; computing a first stochastic transition matrix from the sequence of symbols; reversing the sequence of symbols, wherein the reversing generates a backward sequence of symbols; computing a second stochastic transition matrix from the backward sequence of symbols; computing a first vector of eigenvalues based on the first stochastic transition matrix; computing a second vector of eigenvalues based on the first stochastic transition matrix; and computing a final vector of features based on the first vector of eigenvalues and the second vector of eigenvalues.

### BACKGROUND

### 1. Field of the Invention

Aspects generally relate to systems and methods for detection of anomalous behavior.

### 2. Description of the Related Art

Many processes in nature produce time-stamped observations that can characterize certain behavior. Time-series signals may be leveraged to describe the nature of a given processes. Advantages to such techniques include the ability to capture both transient and steady state components of the dynamics of given time-series signals, leveraging transient and/or steady state components of dynamics to establish enhanced accuracy of detection of anomalous behavior of time-series signals, and the ability to apply the techniques to business issues, such as the early detection of employees' attrition, and cyber-attacks on complex systems.

### SUMMARY

In some aspects, the techniques described herein relate to a method including: receiving a time series signal; converting the time series signal into a sequence of symbols; computing a first stochastic transition matrix from the sequence of symbols; reversing the sequence of symbols, wherein the reversing generates a backward sequence of symbols; computing a second stochastic transition matrix from the backward sequence of symbols; computing a first vector of eigenvalues based on the first stochastic transition matrix; computing a second vector of eigenvalues based on the first stochastic transition matrix; and computing a final vector of features based on the first vector of eigenvalues and the second vector of eigenvalues.

In some aspects, the techniques described herein relate to a method, wherein the final vector of features is computed as a concatenation of the first vector of eigenvalues and the second vector of eigenvalues.

In some aspects, the techniques described herein relate to a method, including: partitioning the time series signal into a plurality of samples using a partitioning process.

In some aspects, the techniques described herein relate to a method, wherein the plurality of samples is mapped to the sequence of symbols.

In some aspects, the techniques described herein relate to a method, wherein the partitioning process is a clustering process.

In some aspects, the techniques described herein relate to a method, wherein the partitioning process is an equidistance partitioning process.

In some aspects, the techniques described herein relate to a method, including: inputting the sequence of symbols to a D-Markov machine, wherein the D-Markov machine outputs a plurality of probability variables based on the sequence of symbols.

In some aspects, the techniques described herein relate to a method, including: computing a probability for each of the plurality of probability variables using.

In some aspects, the techniques described herein relate to a system including at least one computer including a processor, wherein the at least one computer is configured to: receive a time series signal; convert the time series signal into a sequence of symbols; compute a first stochastic transition matrix from the sequence of symbols; reverse the sequence of symbols, wherein the reversing generates a backward sequence of symbols; compute a second stochastic transition matrix from the backward sequence of symbols; compute a first vector of eigenvalues based on the first stochastic transition matrix; compute a second vector of eigenvalues based on the first stochastic transition matrix; and compute a final vector of features based on the first vector of eigenvalues and the second vector of eigenvalues.

In some aspects, the techniques described herein relate to a system, wherein the final vector of features is computed as a concatenation of the first vector of eigenvalues and the second vector of eigenvalues.

In some aspects, the techniques described herein relate to a system, wherein the at least one computer is configured to: partition the time series signal into a plurality of samples using a partitioning process.

In some aspects, the techniques described herein relate to a system, wherein the plurality of samples is mapped to the sequence of symbols.

In some aspects, the techniques described herein relate to a system, wherein the partitioning process is a clustering process.

In some aspects, the techniques described herein relate to a system, wherein the at least one computer is configured to: input the sequence of symbols to a D-Markov machine, wherein the D-Markov machine outputs a plurality of probability variables based on the sequence of symbols; and compute a probability for each of the plurality of probability variables using.

In some aspects, the techniques described herein relate to a non-transitory computer readable storage medium, including instructions stored thereon, which instructions, when read and executed by one or more computer processors, cause the one or more computer processors to perform steps including: receiving a time series signal; converting the time series signal into a sequence of symbols; computing a first stochastic transition matrix from the sequence of symbols; reversing the sequence of symbols, wherein the reversing generates a backward sequence of symbols; computing a second stochastic transition matrix from the backward sequence of symbols; computing a first vector of eigenvalues based on the first stochastic transition matrix; computing a second vector of eigenvalues based on the first stochastic transition matrix; and computing a final vector of features based on the first vector of eigenvalues and the second vector of eigenvalues.

In some aspects, the techniques described herein relate to a non-transitory computer readable storage medium, wherein the final vector of features is computed as a concatenation of the first vector of eigenvalues and the second vector of eigenvalues.

In some aspects, the techniques described herein relate to a non-transitory computer readable storage medium, including: partitioning the time series signal into a plurality of samples using a partitioning process; and mapping the plurality of samples to the sequence of symbols.

In some aspects, the techniques described herein relate to a non-transitory computer readable storage medium, wherein the partitioning process is an equidistance partitioning process.

In some aspects, the techniques described herein relate to a non-transitory computer readable storage medium, including: inputting the sequence of symbols to a D-Markov machine, wherein the D-Markov machine outputs a plurality of probability variables based on the sequence of symbols.

In some aspects, the techniques described herein relate to a non-transitory computer readable storage medium, including: computing a probability for each of the plurality of probability variables using.

### BRIEF DESCRIPTION OF THE DRAWINGS

FIG. 1 shows a partitioned time series signal, in accordance with aspects.

FIG. 2 shows a calculation of a stochastic transition matrix, in accordance with aspects.

FIG. 3 depicts calculation of a final vector of features from a forward sequence of symbols and a backward sequence of symbols, in accordance with aspects.

FIG. 4 shows computation of a distance between a final vector of features of a nominal time series signal and a final vector of features of an incoming time series signal, in accordance with aspects.

FIG. 5 shows a BiD-STM system and output results, in accordance with aspects.

FIG. 6 shows a classification process, in accordance with aspects.

FIG. 7 is a block diagram of a system for early detection of anomalous behavior, in accordance with aspects.

FIG. 8 is a logical flow for creating a final vector of features, in accordance with aspects.

FIG. 9 is a block diagram of a computing device for implementing certain aspects of the present disclosure.

### DETAILED DESCRIPTION

Aspects generally relate to systems and methods for detection of anomalous behavior.

In accordance with aspects, an efficient data-driven technique for early detection of anomalous behavior of given time-series signals is provided. Aspects may facilitate early prediction of critical events in processes that produce time series signals that may be evaluated. Early detection of anomalous behavior in time-series signals is realized by the identification of their dynamical behavior that results in efficient separation of nominal and anomalous dynamics of the signal. These techniques may be leveraged to address various business-related issues.

For instance, issues in human resources, such as the early detection of employees' attrition may be evaluated. Time series signals generated from daily engagement of employees may be leveraged to identify if an employee is likely to leave an organization. Aspects may be leveraged to inform decision-makers to retain high performing employees across an organization. In other aspects, cyber-attacks on complex systems may be identified using the techniques described herein. Employee attrition and cyber-attacks are discussed herein as exemplary applications of the techniques described herein but these applications are not meant to be limiting. As will be evident, the disclosed techniques may be used to detect anomalous behavior in any number of processes and systems.

In accordance with aspects, feature extraction of the dynamical behavior of a given signal may be performed. A bidirectional stochastic transition matrix (BiD-STM) technique is described that captures the forward and backward dynamics of a given time series signal. In the forward dynamics' extraction, the time series signal may be firstly partitioned using partitioning techniques, such as equidistance partitioning or clustering. The partitioning process provides mapping values of a considered time-series signal into a sequence of symbols, where each sample feature of the signal is mapped to a corresponding symbol.

The obtained sequence of symbols may then be leveraged to extract the stochastic transition matrix, which matrix may characterize the probability of transition from one symbol to another symbol. Finally, the vector of eigenvalues of the extracted stochastic transition matrix is computed.

For the backward dynamics' extraction, similar steps may be employed as with the forward dynamics' extraction, but for the time-reversed version of the time-series signal. The computed vectors of eigenvalues of both the forward and the backward dynamics' extraction may be input into a classification stage (e.g., a binary classifier), thereby realizing an efficient early detection of anomalous behavior of the time-series signal.

In accordance with aspects, a time series signal may be converted into a sequence of symbols. Symbols may be derived from a time series signal using a partitioning process. Any suitable partitioning technique may be used to partition the time series signal (e.g., equidistance partitioning, clustering (such as K-Means clustering), etc.). The partitioning process may partition the Y-axis of a time series signal into a finite number of sample partitions, or samples. A sequence of symbols may be obtained by mapping each sample created from the partitioning process to a corresponding symbol. For instance, if a time series signal is partitioned into three samples, then the samples may be mapped to a sequence of symbols such as S=[s₂, s₃, . . . , s₁], where the three samples are mapped to s₂, s₃ and s₁.

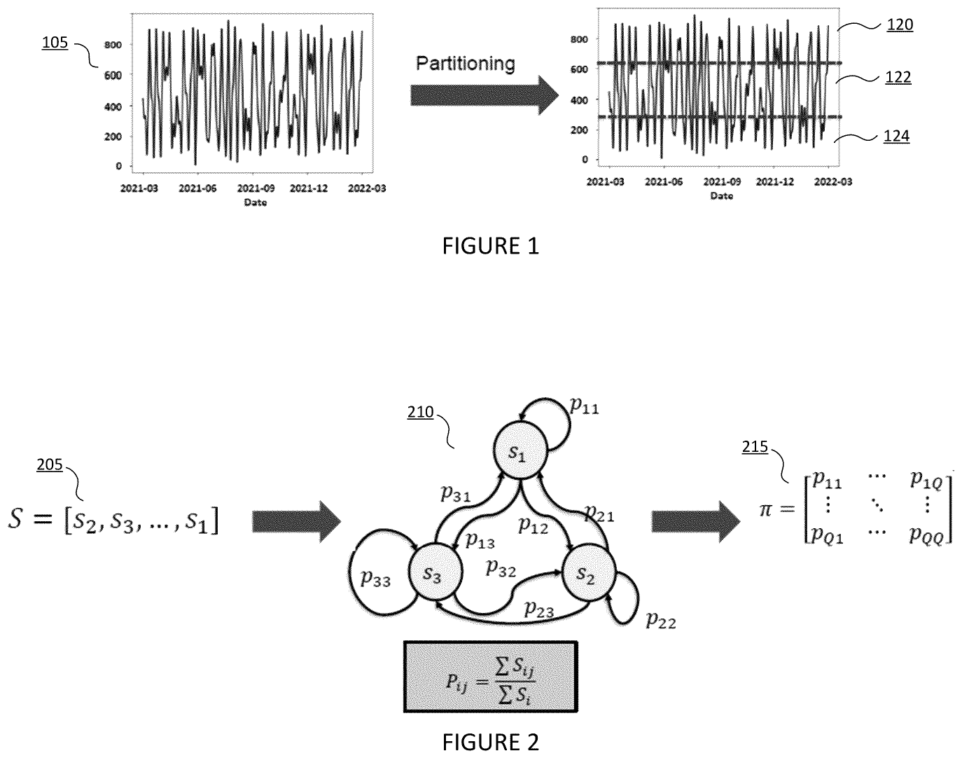

FIG. 1 shows a partitioned time series signal, in accordance with aspects. Time series signal 105 is partitioned into three samples: sample 120, sample 122, and sample 124. Sample 120, sample 122, and sample 124 may then be mapped to symbols S₁, S₂, and S₃. S₁, S₂, and S₃ may comprise a sequence of symbols, such as S=[s₂, s₃, . . . , s₁].

In accordance with aspects, probabilities of a transition from one symbol to another symbol may be calculated from the sequence of symbols. Each symbol in the sequence of symbols may be used as input to a D-Markov machine, and the D-Markov Machine may output a number of probability symbols P. The stochastic transition matrix π(pi) may then be computed by determining Pᵢⱼ for all symbols P provided by the D-Markov machine. Pᵢⱼ may be computed using the formula

$${P}_{i j} = \frac{\sum {S}_{i j}}{\sum {S}_{i}} ,$$

where i=1, 2, 3, . . . , Q, and j=1, 2, 3, . . . , Q are indices of symbols, S_ij is the transition from the ith symbol to the jth symbol, and S_i is the ith symbol.

FIG. 2 shows a calculation of a stochastic transition matrix, in accordance with aspects. Each symbol from sequence of symbols 205 is used as input to D-Markov machine 210. D-Markov machine 210 produces a number of values P (i.e., P₁₁, P₂₁, P₁₂, P₃₁, P₁₃, etc.). Stochastic transition matrix 215 may then be computed by determining Pᵢⱼ for all values P produced by the D-Markov machine. As seen in FIG. 2, the number of rows and columns in the computed stochastic transition matrix is Q.

In accordance with aspects, the vector of eigenvalues that characterize the computed stochastic transition matrix may be computed. The eigenvalues for the computed stochastic transition matrix may be computed, and the eigenvalues may be used to compute the vector of eigenvalues. Vectors of eigenvalues may capture both a steady-state and a transient state of the dynamical behavior of a given time series signal.

In accordance with aspects, the vector of eigenvalues is λ_{FWD}, which is a vector of λ₁, λ₂, . . . , λ_{Q}. Each one of λ₁, λ₂, . . . , λ_{Q} is an eigenvalue to the computed stochastic transition matrix. Accordingly, λ_{FWD}=(λ₁, λ₂, . . . , λ_{Q}). The number of eigenvalues is equal to the number of rows and columns Q in the computed stochastic transition matrix. The computed vector of eigenvalues, λ_{FWD}, is computed for the original, or forward, sequence of symbols derived from the time series signal. In a bidirectional stochastic transition matrix (BiD-STM), however, a vector of eigenvalues for the reversed (i.e., the backward) sequence of the same symbols may be computed.

In accordance with aspects, the sequence of symbols derived from the time series signals may be reversed and the backward vector of eigenvalues may be computed by performing the calculations described above on the reversed sequence of symbols. For instance, given the forward sequence of symbols S=[s₃, s₂, . . . , s₂], the backward sequence of symbols may be S=[s₂, s₃, . . . , s₃]. A stochastic transition matrix may be computed for the backward sequences of symbols (as described above), and the backward vector of eigenvalues, λ_{BWD}, may be computed (also as described above), where λ_{BWD}=(λ₁, λ₂, . . . , λ_{Q}) for the stochastic transition matrix compute for the backward sequence of symbols. Once the backward vector of eigenvalues has been calculated, the forward and backward vectors of eigenvalues may be concatenated to compose the final vector of features, λ_{F}, where λ_{F}=(λ_{FWD}, λ_{BWD}).

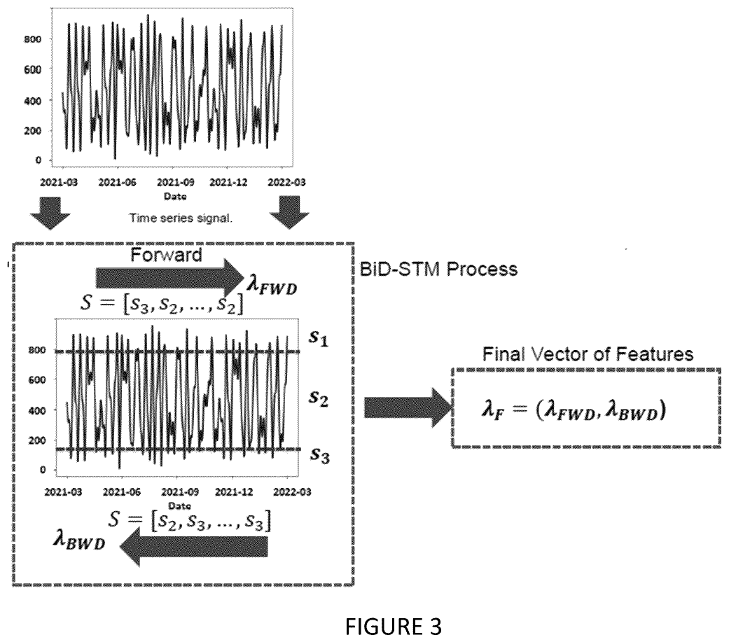

FIG. 3 depicts calculation of a final vector of features from a forward sequence of symbols and a backward sequence of symbols, in accordance with aspects.

In accordance with aspects a distance may be computed between a final vector of features computed from a nominal (i.e., a normal or baseline) time series signal and a final vector of features computed from an incoming time series signal to determine whether the incoming time series signal captured anomalous patterns. The disclosed BiD-STM technique may be applied to a nominal time series signal, which will give λ*_{F} that is the final vector of features of the nominal time series signal. The disclosed BiD-STM may also be applied to an incoming time series signal, thereby producing λ_{F}, which is the final vector of features of the incoming time series signal. A distance d may then be computed as d(λ*_{F}, λ_{F}). If the computed distance d is less than or equal to a predefined threshold, then the pattern is a nominal (i.e., a normal or non-anomalous) pattern. If, however, the computed distance is greater than the predefined threshold, the pattern is anomalous.

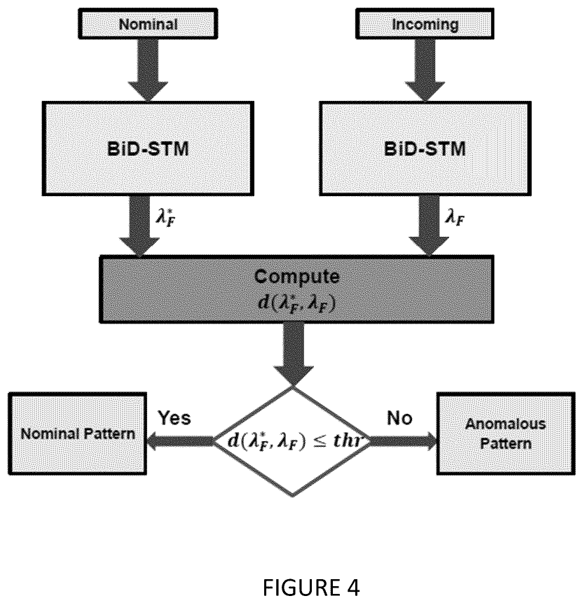

FIG. 4 shows computation of a distance between a final vector of features of a nominal time series signal and a final vector of features of an incoming time series signal, in accordance with aspects.

The techniques described herein may be used to determine anomalous behavior in complex systems where a nominal time series signal has been established. For instance, a complex system such as a duffing system may receive a incoming time signal is always checked against the incoming signal against an established nominal time series signal that acts as a baseline. The nominal time series signal is a result of the dynamic system. In the case of a cyber-attack on the system, however, anomalies may be detected.

For example, nominal values of beta (B) for a duffing system may be between 0.01 and 0.31. A cyber attacker, however, may attempt to change the values of beta. In a cyber-attack, the cyber attacker may attempt to change the value of beta to between, e.g., 0.32 and 0.52. Techniques described herein, however, may provide enhanced detection of the variation introduced to the exemplary duffing system, and may provide improved separation between nominal and anomalous behavior.

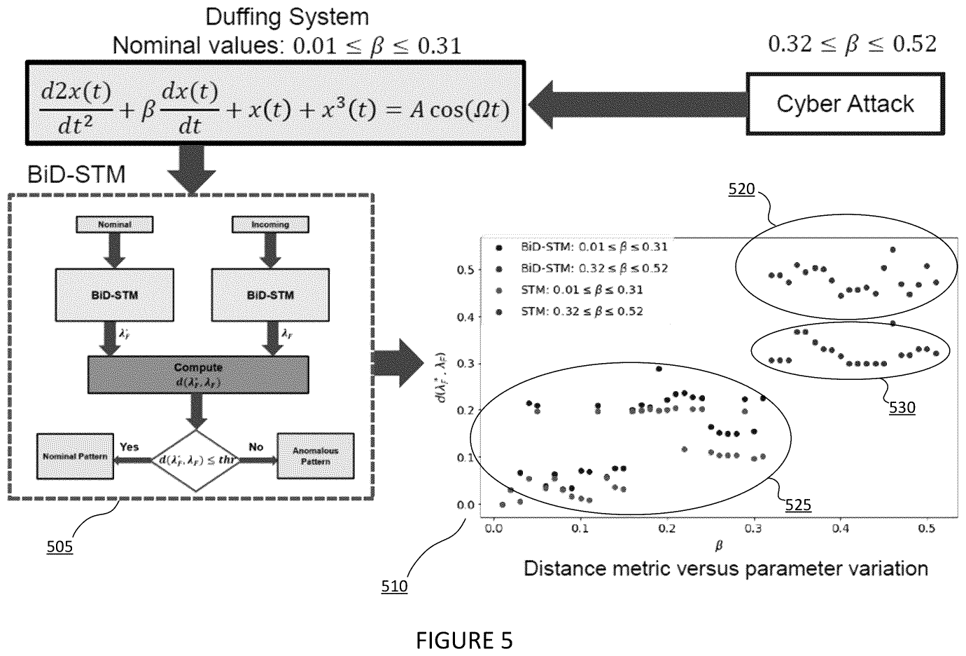

FIG. 5 shows a BiD-STM system and output results, in accordance with aspects. FIG. 5 incudes BiD-STM system 505 (which is shown in greater detail in FIG. 4). BiD-STM system 505 is shown as applied to a cyber-attack scenario, as described, above, where a cyber attacker has changed the values of beta (B) to values outside of the nominal window. That is, the cyber attacker has changed the value of β from between 0.01 and 0.31 to 0.32 and 0.52.

FIG. 5 also includes output chart 510. Output chart 510 shows the calculated distance between output parameters of the nominal time series signal and output parameters of the anomalous incoming time series signal from both BiD-STM system 505 and from conventional stochastic transition matrix computations. Output parameter group 520 is the grouping of output parameters from the anomalous incoming time series signal as calculated by BiD-STM system 505. Output parameter group 525 includes output parameters of the nominal time series signal calculated with both BiD-STM system 505 and from a conventional stochastic transition matrix computation. Output parameter group 530 shows the grouping of output parameters of the anomalous incoming time series signal as calculated by the conventional stochastic transition matrix computation. Notably, BiD-STM system 505 has provided improved distance between the nominal and anomalous behavior groupings, indicating an improved sensitivity of the BiD-STM disclosed herein.

In accordance with aspects, where large numbers of both anomalous samples and of nominal samples of time series signals are available (e.g., hundreds, thousands, or more), the time series signals may be used to train a classification model to make predictions based on received time series signals. In accordance with aspects time series signals may be collected and a final vector of features, λ_{F}, may be computed using the BiD-STM techniques described herein. The computed final vector of features may be labeled as either nominal or anomalous based on historical data.

For instance, for a group of employees where some of the employees resigned and some remained at a particular organization, a time series signal for each employee may be collected. A final vector of features for each time series signal may be computed. Based on historical data, the final time series signal of each employee may be label. The labeling may be binary, e.g., 1 for employees that left the organization and 0 for employees that remained with the organization. The labeled final vectors of features may be used as a training dataset and may be exposed to a binary classification model. Based on the training dataset, the binary classification model may take final vector features computed from time series signals captured for current employees of the organization and may predict whether a current employee will leave the organization or will remain with the organization.

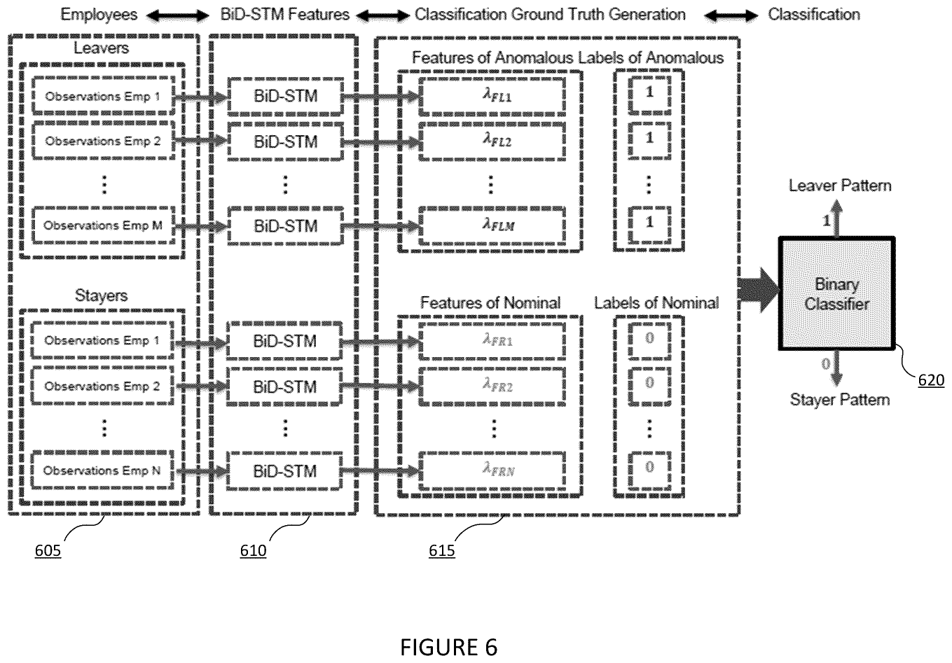

FIG. 6 shows a classification process, in accordance with aspects. Column 605 shows a collection of observations of employees. Column 605 may represent tens, hundreds, thousands, or more employee observations. The observations are categorized into “leavers” and “stayers.” The collection of employees may be categorized according to historical data. For instance, leavers may have previously left the organization and the leavers records may indicate as much. In the same way, stayers may be currently employed by the organization, or observations of stayers may be for time periods where the stayers were employed by the organization. The employee observations of column 605 may be in the form of time series signals or may be converted into time series signals.

Column 610 of FIG. 6 shows the time series signals of the employees being processed with BiD-STM techniques, as described herein. Processing by the described BiD-STM techniques, as shown in column 610, results in a final vector of features for each time series signal of each employee as shown by table 615. Each final vector of features is then assigned a corresponding label in table 615. For each final vector of features that has been identified as computed from the time series signal of a leaver employee, a corresponding label of 1 is assigned. Alternatively, for each final vector of features that has been identified as computed from the time series signal of a stayer employee, a corresponding label of 0 is assigned.

Table 615 may then be exposed to binary classifier 620. Binary classifier 620 may be trained on the data in table 615 to recognize leaver patterns and stayer patterns. Thereafter, timeseries signals collected for current employees over defined time periods may be processed with BiD-STM techniques, and the resultant final vector of features may be ingested by binary classifier 620. Binary classifier 620 may output predictions with respect to whether the ingested final vector of features presents a leaver pattern or a stayer pattern.

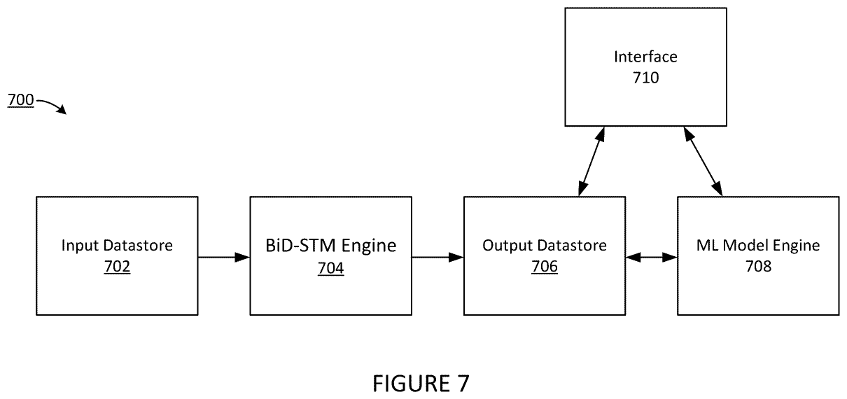

FIG. 7 is a block diagram of a system for early detection of anomalous behavior, in accordance with aspects. System 700 includes input datastore 702, BiD-STM engine 704, output datastore 706, machine learning (ML) model engine 708, and interface 710. Input datastore 702 and output datastore 706 may be any suitable datastore. Input datastore 702 may store observations, and the observations may be in the form of time series signals. BiD-STM engine 704 may be in operative communication with input datastore 702 and may receive time series signals from input datastore 702 for processing. BiD-STM engine 704 may process time series signals as described in more detail, herein.

Output datastore 706 may receive and store output from BiD-STM engine 704. Output received and stored by output datastore 706 may be in the form of final vectors of features for corresponding input to BiD-STM engine 704. Output datastore 706 may also store labels associated with respective final vectors of features, as described in more detail, herein. Output datastore 706 may store final vectors of features and corresponding labels as a table, or in any necessary or desirable format. Interface 710 may be any suitable interface for interacting with or viewing data stored in output datastore 706 or output from ML model engine 708. Interface 710 may be a graphical user interface (GUI), a command line interface, etc.

ML model engine 708 may execute one or more machine learning models, such as binary classification models or any other necessary or desirable machine learning model (e.g., neural network models, decision tree models, etc.). ML model engine 708 may receive data from output datastore 706, process the data, and provide output data in the form of predictions, inferences, etc. Out from ML model engine 708 may be stored in output datastore 706 or a similar datastore. Output data from ML model engine 708 may also be accessed viewed, manipulated, etc. from interface 710.

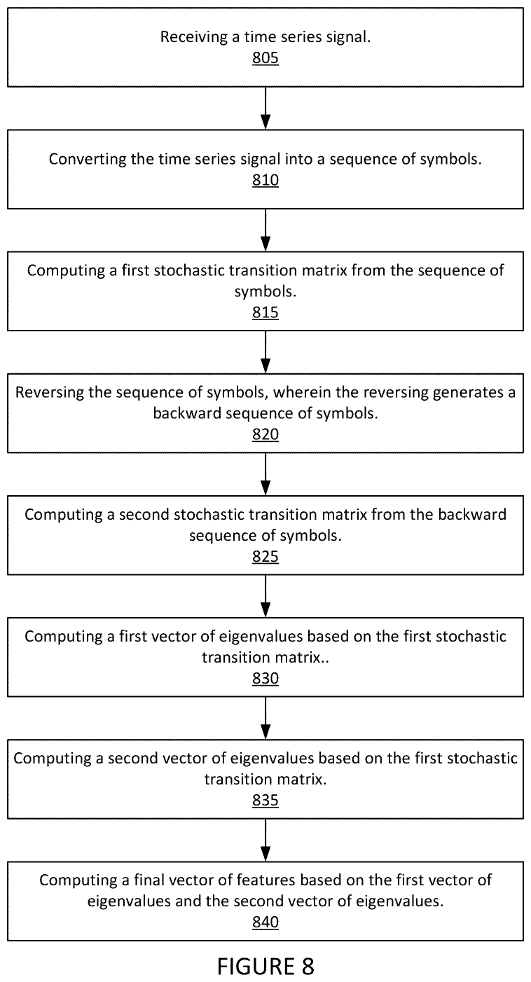

FIG. 8 is a logical flow for creating a final vector of features, in accordance with aspects.

Step 805 includes receiving a time series signal.

Step 810 includes converting the time series signal into a sequence of symbols.

Step 815 includes computing a first stochastic transition matrix from the sequence of symbols.

Step 820 includes reversing the sequence of symbols, wherein the reversing generates a backward sequence of symbols.

Step 825 includes computing a second stochastic transition matrix from the backward sequence of symbols.

Step 830 includes computing a first vector of eigenvalues based on the first stochastic transition matrix.

Step 835 includes computing a second vector of eigenvalues based on the first stochastic transition matrix.

Step 840 includes computing a final vector of features based on the first vector of eigenvalues and the second vector of eigenvalues.

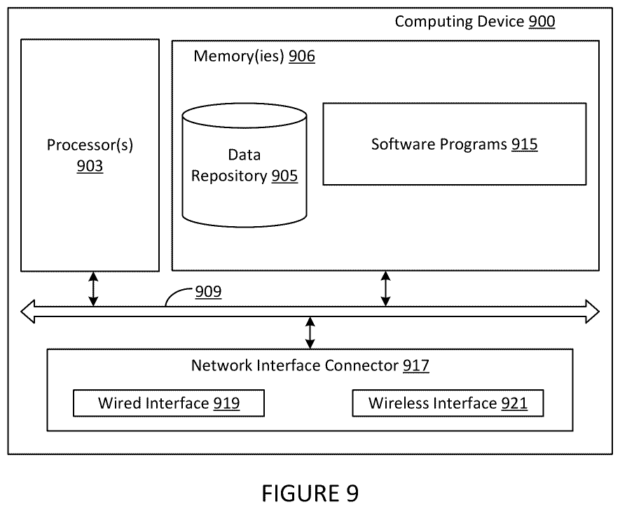

FIG. 9 is a block diagram of a computing device for implementing certain aspects of the present disclosure. FIG. 9 depicts exemplary computing device 900. Computing device 900 may represent hardware that executes the logic that drives the various system components described herein. For example, system components such as a BiD-STM Engine, a ML model engine, an interface, various database engines and database servers, and other computer applications and logic may include, and/or execute on, components and configurations like, or similar to, computing device 900.

Computing device 900 includes a processor 903 coupled to a memory 906. Memory 906 may include volatile memory and/or persistent memory. The processor 903 executes computer-executable program code stored in memory 906, such as software programs 915. Software programs 915 may include one or more of the logical steps disclosed herein as a programmatic instruction, which can be executed by processor 903. Memory 906 may also include data repository 905, which may be nonvolatile memory for data persistence. The processor 903 and the memory 906 may be coupled by a bus 909. In some examples, the bus 909 may also be coupled to one or more network interface connectors 917, such as wired network interface 919, and/or wireless network interface 921. Computing device 900 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving a time series signal;
converting the time series signal into a sequence of symbols;
computing a first stochastic transition matrix from the sequence of symbols;
reversing the sequence of symbols, wherein the reversing generates a backward sequence of symbols;
computing a second stochastic transition matrix from the backward sequence of symbols;
computing a first vector of eigenvalues based on the first stochastic transition matrix;
computing a second vector of eigenvalues based on the first stochastic transition matrix; and
computing a final vector of features based on the first vector of eigenvalues and the second vector of eigenvalues.

2. The method of claim 1, wherein the final vector of features is computed as a concatenation of the first vector of eigenvalues and the second vector of eigenvalues.

3. The method of claim 1, comprising:
partitioning the time series signal into a plurality of samples using a partitioning process.

4. The method of claim 3, wherein the plurality of samples is mapped to the sequence of symbols.

5. The method of claim 3, wherein the partitioning process is a clustering process.

6. The method of claim 3, wherein the partitioning process is an equidistance partitioning process.

7. The method of claim 1, comprising:
inputting the sequence of symbols to a D-Markov machine, wherein the D-Markov machine outputs a plurality of probability variables based on the sequence of symbols.

8. The method of claim 7, comprising:
computing a probability for each of the plurality of probability variables using
$${P}_{i j} = \frac{\sum {S}_{i j}}{\sum {S}_{i}} .$$

9. A system comprising at least one computer including a processor, wherein the at least one computer is configured to:
receive a time series signal;
convert the time series signal into a sequence of symbols;
compute a first stochastic transition matrix from the sequence of symbols;
reverse the sequence of symbols, wherein the reversing generates a backward sequence of symbols;
compute a second stochastic transition matrix from the backward sequence of symbols;
compute a first vector of eigenvalues based on the first stochastic transition matrix;
compute a second vector of eigenvalues based on the first stochastic transition matrix; and
compute a final vector of features based on the first vector of eigenvalues and the second vector of eigenvalues.

10. The system of claim 9, wherein the final vector of features is computed as a concatenation of the first vector of eigenvalues and the second vector of eigenvalues.

11. The system of claim 9, wherein the at least one computer is configured to:
partition the time series signal into a plurality of samples using a partitioning process.

12. The system of claim 11, wherein the plurality of samples is mapped to the sequence of symbols.

13. The system of claim 11, wherein the partitioning process is a clustering process.

14. The system of claim 9, wherein the at least one computer is configured to:
input the sequence of symbols to a D-Markov machine, wherein the D-Markov machine outputs a plurality of probability variables based on the sequence of symbols; and
compute a probability for each of the plurality of probability variables using
$${P}_{i j} = \frac{\sum {S}_{i j}}{\sum {S}_{i}} .$$

15. A non-transitory computer readable storage medium, including instructions stored thereon, which instructions, when read and executed by one or more computer processors, cause the one or more computer processors to perform steps comprising:
receiving a time series signal;
converting the time series signal into a sequence of symbols;
computing a first stochastic transition matrix from the sequence of symbols;
reversing the sequence of symbols, wherein the reversing generates a backward sequence of symbols;
computing a second stochastic transition matrix from the backward sequence of symbols;
computing a first vector of eigenvalues based on the first stochastic transition matrix;
computing a second vector of eigenvalues based on the first stochastic transition matrix; and
computing a final vector of features based on the first vector of eigenvalues and the second vector of eigenvalues.

16. The non-transitory computer readable storage medium of claim 15, wherein the final vector of features is computed as a concatenation of the first vector of eigenvalues and the second vector of eigenvalues.

17. The non-transitory computer readable storage medium of claim 15, comprising:
partitioning the time series signal into a plurality of samples using a partitioning process; and
mapping the plurality of samples to the sequence of symbols.

18. The non-transitory computer readable storage medium of claim 17, wherein the partitioning process is an equidistance partitioning process.

19. The non-transitory computer readable storage medium of claim 15, comprising:
inputting the sequence of symbols to a D-Markov machine, wherein the D-Markov machine outputs a plurality of probability variables based on the sequence of symbols.

20. The non-transitory computer readable storage medium of claim 19, comprising:
computing a probability for each of the plurality of probability variables using
$${P}_{i j} = \frac{\sum {S}_{i j}}{\sum {S}_{i}} .$$
